(19) United States
(12) Patent Application Publication
(10) Pub. No.: US 2021/0252736 A1
(43) Pub. Date: Aug. 19, 2021

(54) APPARATUS AND METHOD FOR PAINTING OR STAINING BOARDS

(71) Applicant: Anthony Blackwelder, Bend, OR (US)

(72) Inventor: Anthony Blackwelder, Bend, OR (US)

(21) Appl. No.: 17/175,257

(22) Filed: Feb. 12, 2021

Related U.S. Application Data
(60) Provisional application No. 62/975,903, filed on Feb. 13, 2020.

(51) Int. Cl. B27K 3/02; B05B 13/02; B05B 16/80; B05B 16/20; B05B 14/30

(52) U.S. Cl. CPC B27K 3/0228; B05B 13/0207; B05B 14/30; B05B 16/20; B05B 16/80

(57) ABSTRACT

A system that applies liquid conditioning agent to at least one of a plurality of sides of an untreated board is provided. One embodiment has an enclosure with a first side having a first aperture and an opposing second side with a second aperture having dimensions that correspond to the width and thickness of the untreated board; a spray applicator system comprising a plurality of spray nozzles located within a chamber and oriented inward, wherein the liquid conditioning agent is sprayed through the spray nozzles onto at least one of the sides of the untreated board as the untreated board passes through the chamber of the enclosure; a plurality of brushes located after the spray applicator system, wherein the liquid conditioning agent is brushed onto the sides of the untreated board, wherein the untreated board enters through the first aperture, and wherein a treated board exits through the second aperture.

### PRIORITY CLAIM

This application claims priority to copending U.S. Application, Ser. No. 62/975,903, filed on Feb. 13, 2020, entitled APPARATUS AND METHOD FOR PAINTING OR STAINING BOARDS, which is hereby incorporated by reference for all purposes.

### BACKGROUND OF THE INVENTION

In the arts of building construction, and in particular conditioning of interior trim, exterior trim, deck, and fences, a variety of different and complex paint and stain treatment systems are known that are operable to treat building materials. For example, wood or composite material trim boards may be painted, stained, and/or coated with a finish prior to installation at the construction site. Deck and/or siding planks may be painted, stained and/or finished prior to installation when building a deck. Fence planks may be painted, stained and/or finished prior to installation when building a deck. Such trim boards, deck planks, siding planks, and fence planks are generically referred to herein as “boards” for convenience and brevity.

However, such building material treatment systems are typically large and bulky, and are expensive to fabricate and install. Accordingly, such building material treatment systems are used at manufacturing facilities that manufacture the board products and/or that distribute the board products. The treated boards may then be shipped in bulk to a distributions site and/or to a construction site. Such legacy building material treatment systems are entirely unsatisfactory for use at a building or construction site because of their large size and high cost.

Alternatively, untreated boards may be delivered to the building or construction site for installation. Prior to installation, or after installation, the boards may be painted, stained and/or finished by the work crew at the building or construction site. However, such manual efforts to paint, stain or finish the boards before or after installation may be time extensive with a high attendant labor cost. Further, the applied evaporating paint, stain or finish may pollute the environment and/or may even be hazardous to the health of the work crew. Also, there may be a significant amount of paint, stain or finish wastage, particularly if the paint, stain or finish is applied to the boards using a spray system.

Accordingly, there is a need in the arts for a system and method of applying paint, stain or finish to untreated boards at a building or construction site, where the paint, stain or finish is applied to the boards in a safe and environmentally friendly manner.

### SUMMARY OF THE INVENTION

Embodiments of the board treatment system provide a system and method for applying coatings of a liquid conditioning agent, such as a paint, a stain or a finish, to boards passing through an enclosure. An example embodiment is a system that applies liquid conditioning agent to at least one of a plurality of sides of an untreated board. One embodiment has an enclosure with a first side having a first aperture and an opposing second side with a second aperture, the enclosure having dimensions that correspond to the width and thickness of the untreated board; a spray applicator system comprising a plurality of spray nozzles located within a chamber and oriented inward, wherein the liquid conditioning agent is sprayed through the spray nozzles onto at least one of the sides of the untreated board as the untreated board passes through the chamber of the enclosure; a plurality of brushes located after the spray applicator system, wherein the liquid conditioning agent is brushed onto the sides of the untreated board, wherein the untreated board enters through the first aperture, and wherein a treated board exits through the second aperture

### BRIEF DESCRIPTION OF THE DRAWINGS

The components in the drawings are not necessarily to scale relative to each other. Like reference numerals designate corresponding parts throughout the several views.

FIG. 1 is a perspective diagram of an embodiment of a board treatment system.

FIG. 2 is a transparent perspective diagram of selected internal components of an embodiment of the board treatment system.

FIG. 3 is a perspective view of an example internal support frame located in the chamber of the enclosure.

FIG. 4 is a front view of an example frame located in the chamber of the enclosure.

FIG. 5 is a perspective view showing the exterior of the exit side and the first side of an enclosure.

FIG. 6 is a perspective view showing the exterior of the exit side and the first side of an enclosure.

FIG. 7 is a perspective view of the exit side of the internal support frame showing the plurality of brushes.

FIG. 8 is a perspective top view of the enclosure illustrating treatment of an example board as it is being passed through the board treatment system.

### DETAILED DESCRIPTION

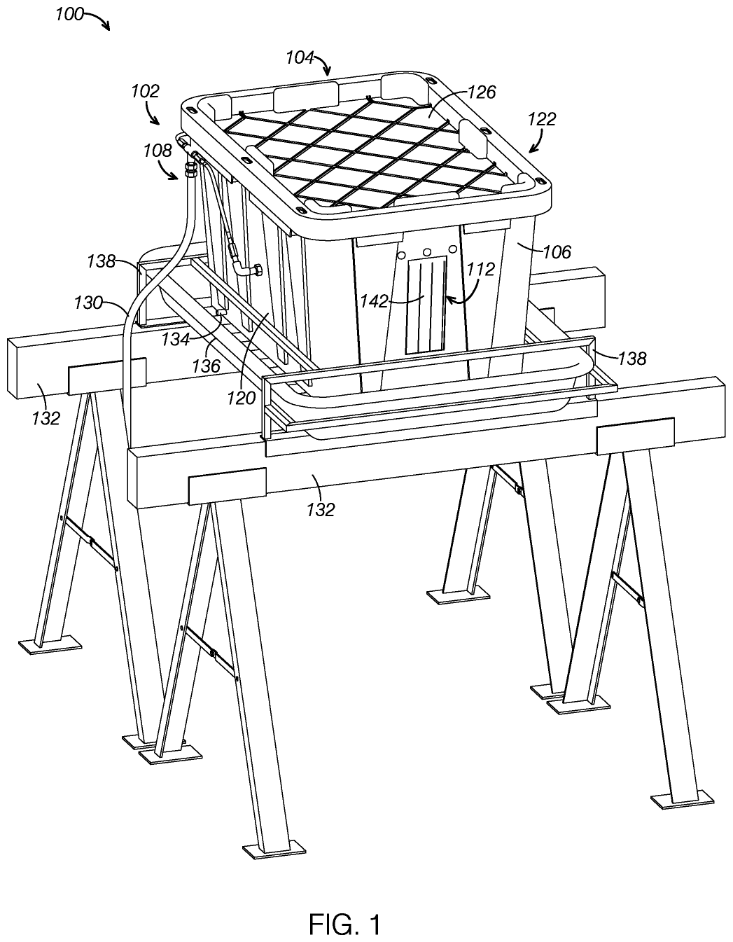

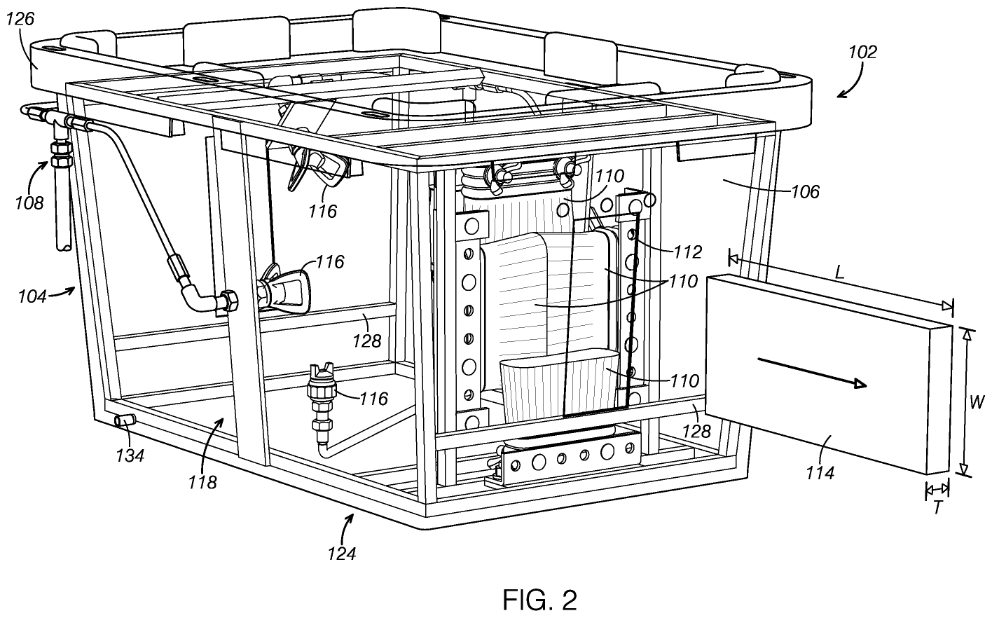

FIG. 1 is a perspective diagram of an embodiment of a board treatment system 100. FIG. 2 is a transparent perspective diagram of selected internal components of an embodiment of the board treatment system 100

Embodiments of the board treatment system 100 provide a system and method for coating boards with a liquid conditioning agent, such as a paint, a stain or a finish, at a construction site. Preferably, the liquid conditioning agent is applied to the boards using a pressurized liquid spray system. Embodiments of the board treatment system 100 are relatively small, and are therefore easy to transport and set up for use at a work site. Further, the board treatment system 100 is easy to clean by the work crew. And, drained liquid conditioning agent can be returned to the source container for immediate re-use while the board treatment system 100 is being used to condition or treat boards. Here, a board is a relatively long piece of building material with a relatively narrow width and a relatively small thickness, such as a piece of interior trim or molding, exterior trim or molding, deck board, side board, fence board, or the like. The board material may be natural wood, wood composite, polyurethane, polystyrene, cement, fiber cement, or the like.

The disclosed board treatment system 100 will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various board treatment systems 100 are provided for painting, staining and/or finishing a board. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

In an exemplary embodiment, the board treatment system 100 comprises an enclosure 102 defined by an entry side 104 and an opposing exit side 106, a spray applicator system 108, and a plurality of brushes 110. The entry side 104 is defined by a first aperture 112 that is preferably shaped as a rectangular slot that substantially corresponds to the width (W) and thickness (T) of the board 114 that is to be treated. The exit side 106 is defined by a second aperture 112 that preferably corresponds to the dimensions of the first aperture 112. In alternative embodiments, the dimensions of the apertures 112 may be different from each other. In some embodiments, the dimensions of the apertures 112 may be adjustable to accommodate boards 114 of different dimensions.

The spray applicator system 108 comprises a plurality of spray nozzles 116 that are directed inward into a central region of the chamber 118 of the enclosure 102. In a preferred embodiment, a first spray nozzle 116 is located centrally on a first side 120 of the enclosure 102 (that is between the entry side 104 and the exit side 106). In some embodiments, a plurality of first spray nozzles 116 may be located proximate to the first side 120 above/below each other to provide a broader area of spray coverage.

An optional second spray nozzle 116 is located centrally on a second side 122 of the enclosure 102 (opposing the first side 120). In some embodiments, a plurality of first spray nozzles 116 may be located proximate to the second side 122 above/below each other to provide a broader area of spray coverage.

One or more optional upward directed spray nozzles 116 may be located centrally proximate to a bottom 124 of the enclosure 102. In some embodiments, a plurality of spray nozzles 116 may be located proximate to the bottom 124 that are adjacent to each other to provide a broader area of spray coverage.

An optional downward directed spray nozzle 116 may be located centrally proximate to the enclosure cover 126 of the enclosure 102. In some embodiments, a plurality of spray nozzles 116 may be located proximate to the cover 126 that are adjacent to each other to provide a broader area of spray coverage.

The spray nozzles 116 are preferably releasably secured to the internal support frame 128. Here, different spray nozzles 116 may be used for different sized boards 114. Additionally, the spray nozzles 116 may be removed for cleaning of the brushes 110, the internal support frame 128, the spray nozzles 116 and the interior of the chamber 118 after use.

Preferably, the spray applicator system 108 includes a plurality of hoses and hose connectors that are fluidly coupled to each one of the spray nozzles 116. In some embodiments, optional shutoff valves or the like may be used to facilitate control of fluid movement through the spray applicator system 108. A hose inlet 130 is coupled to a reservoir, a source container, or the like (not shown) that holds the liquid conditioning agent and to a spray compressor (not shown). Any suitable source container and spray compressor may be used with various embodiments of the board treatment system 100. During operation, the spray applicator system 108 receives a pressurized flow of the liquid conditioning agent such that the liquid conditioning agent is delivered to and then sprayed out by the spray nozzles 116 when the spray nozzles 116 are actuated. The diameter of the orifice of the spray nozzles 116 defines the amount of liquid conditioning agent that is sprayed out of the spray nozzles 116 when actuated. Other characteristics of the spray nozzles 116 define the spray pattern of the spraying liquid conditioning agent. If the orifice is closed, the spray nozzle 116 is not actuated and no liquid conditioning agent is sprayed from that spray nozzle 116.

In practice, a leading end of the board 114 is inserted into the enclosure 102 through the first aperture 112 on the entry side 104 of the enclosure 102. The spray applicator system 108, having the plurality of spray nozzles 116, sprays a liquid conditioning agent, such as a paint, stain or finish, onto the board 114 as a user (or a machine) pushes the board 114 into and through the chamber 118.

Depending upon the work project, the user may selectively open or close the apertures of the spray nozzles 116, and/or selectively pick particular spray nozzles 116, to control the amount of flow of and/or the spread pattern of the liquid conditioning agent so that the board 114 is coated with the liquid conditioning agent in a desired manner. For example, but not limited to, a heavy coat of liquid conditioning agent may be required on one side of the board 114 while a thinner coating, or even no coating, of the liquid conditioning agent is to be applied to the opposing side of the board 114. Here, the first spray nozzle 116 on the first side 120 may be fully opened and the opposing spray nozzle 116 on the second side 122 may be restricted or even shut off. Further, if little or no liquid conditioning agent is needed on the top surface of the board 114, the downward directed spray nozzle 116 may be restricted to little or no spraying of the liquid conditioning agent onto the top surface of the board 114. Alternatively, the downward directed spray nozzle 116 may be omitted.

Embodiments include a plurality of brushes 110 located within the chamber 118 downstream of the location of the plurality of spray nozzles 116. Each brush 110 includes a brushing end that oriented towards the second aperture and that is oriented coplanar with a corresponding side of the board 114, wherein the brushing ends of the brushes 110 are in contact with the corresponding side of the board 114 as the board 114 is passing through the second aperture 112. The plurality of brushes 110 are preferably releasably secured to the internal support frame 128. Here, different brushes 110 may be used for different sized boards 114. Additionally, the brushes 110 may be removed for cleaning of the brushes 110 after use. Further, one or more of the brushes 110 may be omitted when the liquid conditioning agent is not applied to a corresponding side of the board 114.

As the board 114 is pushed through the chamber 118 such that the liquid conditioning agent is applied to the board 114, the travelling board 114 them passes through the plurality of brushes 110. The applied liquid conditioning agent is more evenly spread across the surfaces of the board 114 by the brushes 110. Further, the brushes 110 may facilitate removal of any excess liquid conditioning agent from the board 114.

One skilled in the art appreciates that gravity will pull excess sprayed liquid conditioning agent to the bottom of the board 114. In some embodiments, a lower brush 110 may spread dripping excess liquid conditioning agent along the bottom side of the board 114 such that the upward directed spray nozzle 116 is not needed, or may be turned off. However, if more liquid conditioning agent is desired on the bottom surface of the board, the bottom surface of the board may be sprayed with liquid conditioning agent using the upward directed spray nozzle 116.

FIG. 1 further illustrates an embodiment of the board treatment system 100 adapted for use at a building site or construction site by the work crew, where an individual (interchangeably referred to herein as a “user”) may feed individual boards 102 through the board treatment system 100 so that the liquid conditioning agent, such as a paint, stain or finish, is applied to the board 114. As is apparent to one skilled in the art, the example board treatment system 100 is relatively small and is illustrated, in this non-limiting example, as resting upon work surface 132, here two support structures (commonly known as “saw horses”).

It is appreciated that the example board treatment system 100 may be placed on any suitable work surface 132, such as a table, a plurality of saw horses, a platform, a truck bed, or even the ground, so that the user has ready access to the board treatment system 100. Further, one skilled in the art appreciates that in view of its size, the board treatment system 100 is relatively light in weight so that one or more individuals may manually move an assembled enclosure 102 to a desired work location with relative ease and convenience.

An example embodiment of the enclosure 102 of the board treatment system 100 is fabricated from a readily available commercial tote box made of a light weight plastic or the like. An optional internal support frame 128 may be added to support the spray applicator system 108 and the brushes 110. The tote box lid may be used to keep overspray of the liquid conditioning agent within the chamber 118. If a rigid or substantially rigid enclosure 102 is used, the spray applicator system 108, the spray nozzles 116, and/or the brushes 110 may be secured to the side walls of the enclosure 102.

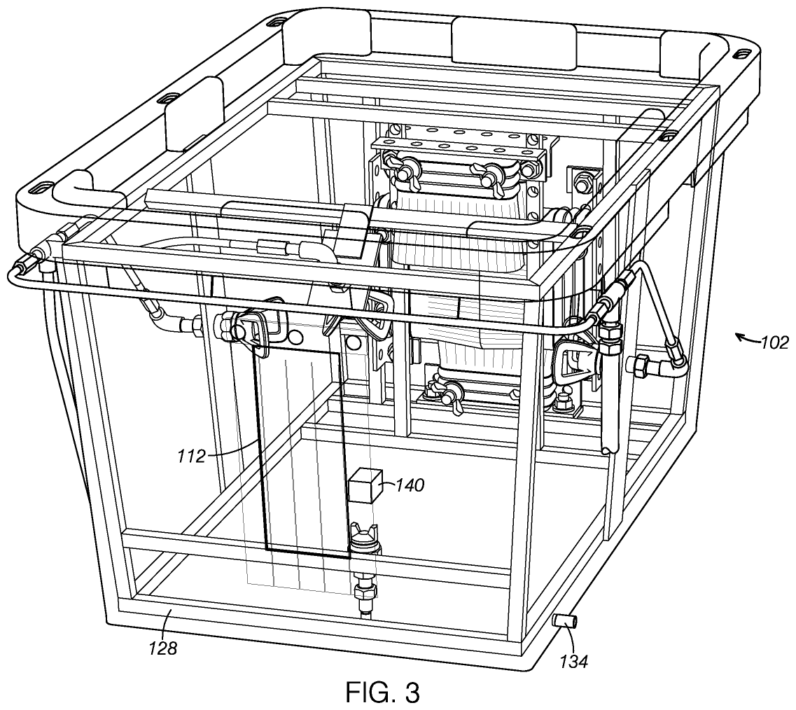

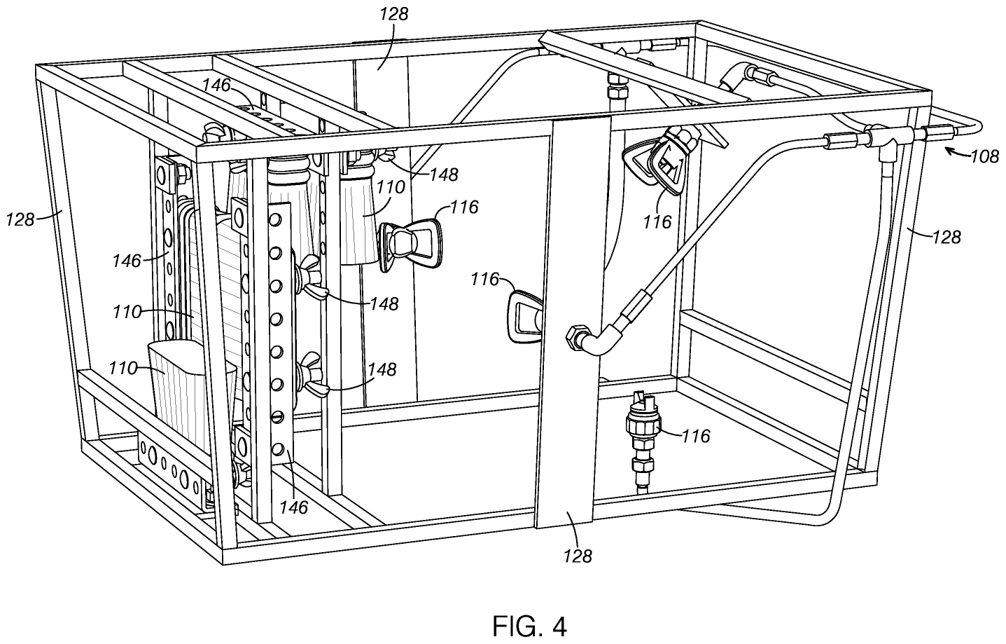

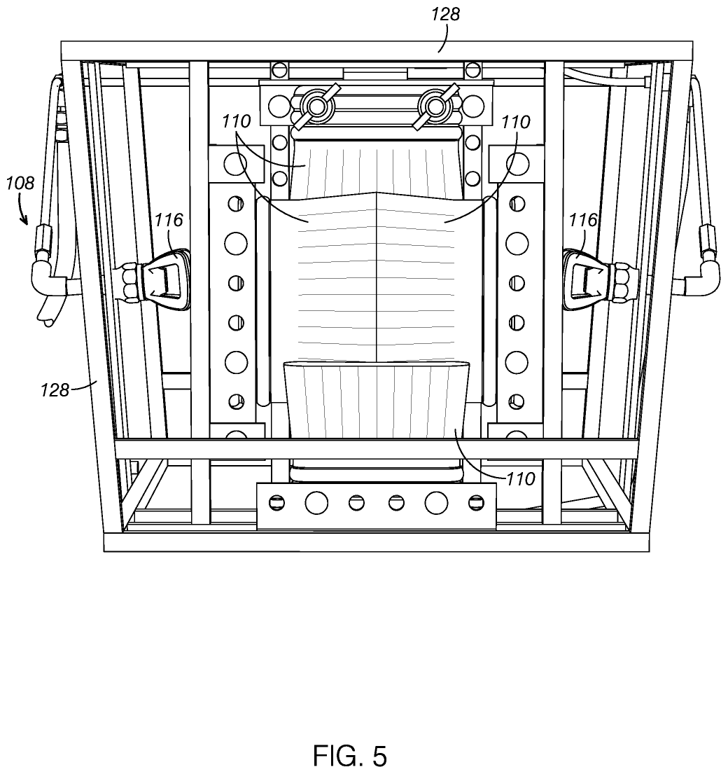

FIG. 3 is a perspective view of an example internal support frame 128 located in the chamber 118 of the enclosure 102. FIG. 4 is a front view of an example frame 128 located in the chamber 118 of the enclosure 102. FIG. 5 is a perspective view showing the exterior of the exit side 106 and the first side 120 of an enclosure 102.

The internal support frame 128 may be made of any suitable rigid or substantially rigid material. In a preferred embodiment, the internal support frame 128 is made of angle iron or the like that is readily available. The material of the internal support frame 128 may be cut to size and assembled to fit within the chamber 118 of the enclosure 102. Preferably, portions of the internal support frame 128 are configured to allow positioning of the spray nozzles 116 and the brushes 110 at desired locations and/or orientations within the chamber 118.

An unexpected benefit is that overspray is retained within the enclosure 102 thereby preventing, or at least reducing, environmental pollution and enhancing safety of the user (who will not be exposed to the risk of inhaling overspray). Also, individual boards 114 can be more quickly and efficiently coated on all or selected sides with the liquid conditioning agent, thereby reducing work time at the building or construction site. And, any overspray or liquid conditioning agent that is removed by the plurality of brushes 110 is retained within the enclosure 102 for reuse.

Example embodiments may include a fluid outlet 134 (drain) disposed at a suitable location along the bottom edge of the enclosure 102. The fluid outlet 134 may be a valve or the like that may be opened or closed. Alternatively, the fluid outlet 134 may be a hole, slot, or other suitable aperture that permits release of accumulated liquid conditioning agent out from the enclosure 102.

As the overspray accumulates in the bottom of the chamber 118, the fluid outlet 134 may be opened to allow exit of the accumulated liquid overspray from the chamber 118. A hose (not shown) coupled to the fluid outlet 134 may be used to transfer the exiting fluid back to the source container that is holding the liquid conditioning agent. Accordingly, waste of the liquid conditioning agent is significantly reduced during operation since the returned liquid conditioning agent may be recycled through the spray applicator system 108. A filter may be optionally used to remove undesirable particulates from the liquid conditioning agent as it is being drained from the enclosure 102. An unexpected advantage is that the mixing of the returning liquid conditioning agent mixes with the liquid conditioning agent in the source container acts to keep the state of the liquid conditioning agent that is being drawn from the source container in a relatively consistent state, thereby assuring that the conditioned boards appear to have a relatively consistent appearance after application of the liquid conditioning agent.

Optionally, a fluid retention tray 136 may be used to retain any incidental spillage of the liquid conditioning agent from the enclosure 102. The fluid retention tray 136 is configured to collect and to retain any unintentional spillage of the liquid conditioning agent, thereby protecting the ambient environment from contamination. In some embodiments, the bottom of the fluid retention tray 136 may be sloped at some predefined angle or grade to facilitate collection of liquid conditioning agent that has accumulated in the bottom of the fluid retention tray 136.

A securing frame 138 may be used to secure the fluid retention tray 136 to the work surface 132. Once the fluid retention tray 136 has been secured to the work surface 132, and after adjustment of the spray nozzles 116 and or brushes 110 have been made based on the dimensions of the board 114 that is to be treated, the enclosure 102 may be lifted and placed into its position on the fluid retention tray 136. Further, in some embodiments, the securing frame 138 may be further configured to releasably secure the enclosure 102 so that the enclosure 102 does not move during use.

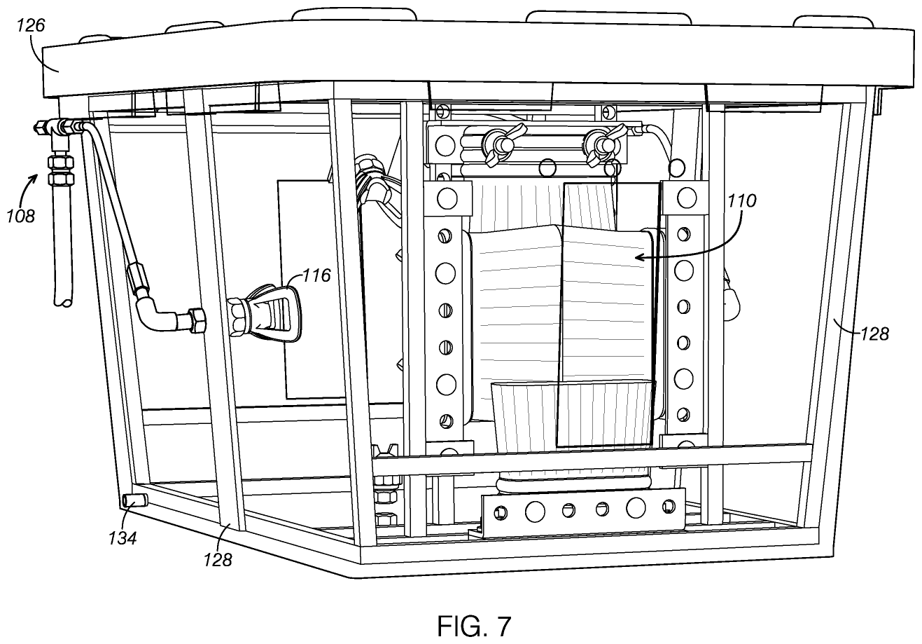

Additionally, or alternatively, the fluid retention tray 136 may also have a drain 144 (FIG. 7) similar to, or the same as, the fluid outlet 134. An optional filter may be used to filter any draining liquid conditioning agent. As the liquid conditioning agent drains through the drain 144 of the fluid retention tray 136, preferably during operation of the board treatment system 100, the collected liquid conditioning agent may be saved or returned to the liquid conditioning agent source container for reuse, or may be discarded.

Initiation of the operation of the spray applicator system 108 may begin in response to sensing the entry of the leading end of the board 114 through the first aperture 112 on the entry side 104 of the enclosure 102. In an example embodiment, the user manually initiates operation of the spray applicator system 108 to initiate the spraying of the liquid conditioning agent outwardly from the selected spray nozzles 116 onto the board 110 as the board passes through the enclosure 102.

Alternatively, initiation of the operation of the spray applicator system 108 may occur in response to detecting that the leading end 118 of the board 114 is coming in proximity to the spray applicator system 108. Any suitable detector 140 (FIG. 3) may be used, such as an optical system that captures an image of the approaching leading end of the board 114 or a mechanical sensor that is actuated when the leading end of the board 114 touches the mechanical sensor.

After the leading end of the board 114 moves past the spray applicator system 108, the leading end of the board 114 then encounters the plurality of brushes 110. The plurality of brushes 110 are sized and oriented within the interior of the chamber 118, and after the spray applicator system 108, so as to more evenly spread and/or brush in the applied conditioning agent to all six sides, or selected sides, of the board 114. Then, the leading edge of the board 114 is pushed through the second aperture 114 of the exit side 106 of the enclosure 102 so as to exit the chamber 118 of the enclosure 102. If needed, the user may retract and extend the board (pull and then push) in a repeated fashion so that the brushes 110 more evenly spread and apply the liquid conditioning agent to the board 114.

A user may then secure the exiting leading end of the board 114, using their hands or a gripping tool, so as to pull the remainder of the board 114 through the chamber 118 such that the conditioning agent is applied to the entire length (L) of the board 114. As the trailing end of the board 114 moves past the spray applicator system 108, the spray applicator system 108 is preferably shut off so as to stop the spraying the conditioning agent into the chamber 118. Conclusion of the operation of the spray applicator system 108 may be in response to sensing the exiting of the trailing end of the board 114 through the second aperture 114. In an example embodiment, the user may manually shuts off the spray applicator system 108.

Alternatively, ending of the operation of the spray applicator system 108 may be initiated in response to a second detector 140 detecting that the trailing end of the board 114 has moved past the spray applicator system 108. Preferably, the second detector 140 detects the passing of the trailing end of the board 114 past the spray applicator system 108 so that the spray applicator system 108 then automatically shuts off.

In alternative embodiments provisioned with an optional mechanical feed system (not shown), the mechanical feed system may automatically move the inserted board 114 through the board treatment system 100. In such embodiments, a user need only initially insert the board 114, and then handle the exiting board 114 that has been painted, stained and/or finished using the applied conditioning agent. Further, a mechanical feed system may transport or move the board 114 through the enclosure 102 at a predefined rate of speed. The predefined rate of speed may be determined based on a known spray rate, spray pattern, and/or amount of sprayed conditioning agent (per unit time) so that the board 114 is coated with a desired amount of conditioning agent along its entire length.

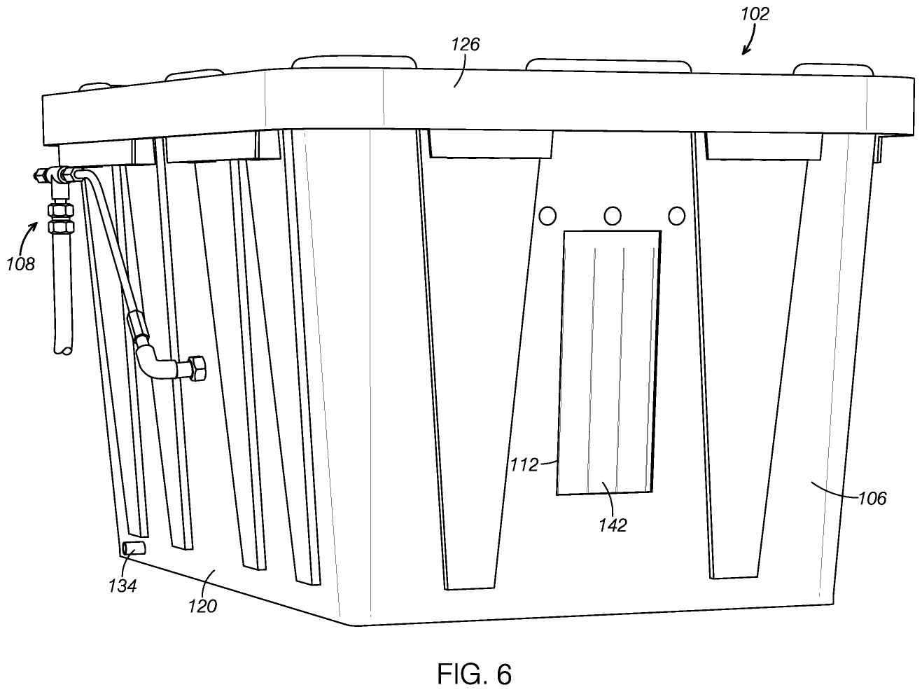

FIG. 6 is a perspective view showing the exterior of the exit side 106 and the first side 120 of the enclosure 102. In some embodiments, an optional plurality of strips of flexible material 142 may be located over the aperture 112 of the exit side 106. The plurality of strips of flexible material 142 permit passage of the board 114 through the aperture 112 while retaining any excess liquid conditioning agent within the interior of the chamber 118. Optionally, similar strips of flexible material 142 may be used to cover the aperture 112 on the entry side 104 of the enclosure 102.

FIG. 7 is a perspective view of the exit side of the internal support frame 128 showing the plurality of brushes 110. The internal support frame 128 may include a rack 146 and a plurality of thumb screws 148 may facilitate releasably securing the brushes 110 in a desired orientation, and at a desired location, within the chamber 118 of the enclosure 102.

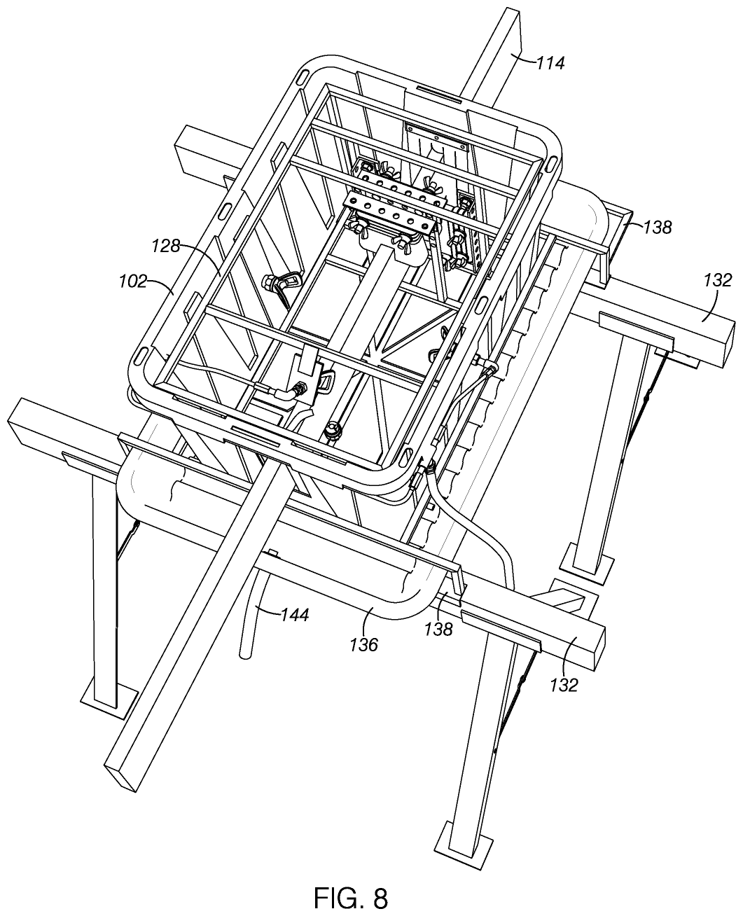

FIG. 8 is a perspective top view of the enclosure 102 illustrating treatment of an example board 114 as it is being passed through the board treatment system 100. One skilled in the art appreciates that a board 114 that is being treated with the liquid conditioning agent may be of any desired length. Preferably, the spray applicator system 108 comprises a plurality of spray nozzles oriented about the board 114 so as to be configured to apply the conditioning agent to all sides of the board 114, including the leading end and trailing ends of the board 114.

In some embodiments, the enclosure cover 126 is removable from the enclosure 102. The enclosure cover 126 is provided to enable user access into the chamber 118. In some embodiments, the enclosure cover 126 may be fabricated in multiple portions and/or may be hinged to one or more of the sides of the enclosure 102.

An optional securing means (not shown) may be used to secure the enclosure cover 126 to the enclosure 102, preferably with an airtight seal, or near air tight seal. Sealing the enclosure cover 126 prevents overspray or the like from escaping the chamber 118, thereby providing protection against unintentional ambient pollution and/or enhancing user safety. Further, retention of any overspray (liquid conditioning agent that has been sprayed into the chamber 118 but that has not been applied to the board 114) can be retained within the chamber 118 for later re-use or disposal.

Any suitable securing means to secure the enclosure cover 126 may be used in the various embodiments. Non-limiting examples include screws with mating threaded apertures, threaded bolts with mated nuts or wing nuts, retainer clips, latches, etc.

When the enclosure cover 126 is removed or opened, the user may readily access the interior of the chamber 118 to adjust and/or replace components of the spray applicator system 108, and/or to adjust and/or replace one or more of the plurality of brushes 110. For example, when the dimensions of the board 114 changes (as different sized boards are treated), the spray nozzles 116 used by the spray applicator system 108 may be reoriented to provide optional spray coverage. Or the spray nozzles 116 may be changed out with different spray nozzles 116. Alternatively, or additionally, the size of the nozzle apertures may be adjusted to change the amount of, the rate of, and/or the spray pattern of the liquid conditioning agent that is sprayed onto the board 114. Alternatively, or additionally, one of more of the plurality of brushes 110 may be re-positioned, reoriented, and/or replaced with different brushes, to accommodate changing board dimensions.

In some embodiments, the entry side 104 and the exit side 106 of the enclosure 102 are made of multiple portions. The first portion is affixed to the opposing sides of the enclosure 102. A removeable second portion includes the apertures 112. Preferably, there are a plurality of like-sized removeable second portions that each secure to the first portion, wherein each second portion has a different sized and/or shaped aperture 112. Each different aperture 112 may have a different dimension and/or shape to accommodate different dimension boards 114 with varying shapes. When the dimensions of a board 114 that is to be treated changes, the user may simply select the second portion so that a corresponding aperture 112 having dimensions and/or shape that are suitable for the new board 114 are used during the board treatment process.

The internal support frame 128 in the illustrated example embodiment further includes a plurality of portions that are configured to secure the plurality of brushes 110. In this example embodiment, four brushes 110 are illustrated. In other applications, any suitable number of brushes 110 may be used. The internal support frame 128 may be configured to receive and secure specially designed brushes 110. In one example embodiment, the base of each brush includes a threaded bolt and the internal support frame 128 contain slots or channels. The user may then slidably adjust the location and/or orientation of individual brushes 110, which may then be secured by tightening a mating nut or the like. Any suitable system may be used to secure the individual brushes 110 in a desired location and/or orientation within the enclosure 102. In some embodiments, the internal support frame 128 is configured to retain and secure legacy paint brushes that have handles for a user's hand.

It should be emphasized that the above-described embodiments of the board treatment system 100 are merely possible examples of implementations of the invention. Many variations and modifications may be made to the above-described embodiments. All such modifications and variations are intended to be included herein within the scope of this disclosure and protected by the following claims.

Furthermore, the disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

Therefore, having thus described the invention, at least the following is claimed:

1. A board treatment system that applies a liquid conditioning agent to at least one of a plurality of sides of an untreated board, comprising:
an enclosure with a first side having a first aperture and an opposing second side with a second aperture, wherein the first aperture and the second aperture have dimensions that correspond to the width and thickness of the untreated board;
a spray applicator system comprising a plurality of spray nozzles located within a chamber and oriented inward towards the chamber of the enclosure, wherein the liquid conditioning agent is sprayed through the spray nozzles onto at least one of the sides of the untreated board as the untreated board passes through the chamber of the enclosure; and
a plurality of brushes located after the spray applicator system and located within a chamber of the enclosure, wherein the liquid conditioning agent is brushed onto the sides of the untreated board by the plurality of brushes as the untreated board passes through the second aperture of the chamber of the enclosure,
wherein the untreated board initially enters the enclosure through the first aperture, and
wherein a treated board exits the enclosure through the second aperture.

2. The board treatment system of claim 1, wherein the plurality of spray nozzles comprises:
a first spray nozzle disposed proximate to a third side of the enclosure and is oriented in towards a central region of the chamber,
wherein the third side of the enclosure is between the first side of the enclosure and the second side of the enclosure, and
wherein first spray nozzle sprays the liquid conditioning agent onto a first surface of the board as the board is passed through the enclosure.

3. The board treatment system of claim 2, wherein the plurality of spray nozzles comprises:
a second spray nozzle disposed proximate to the third side of the enclosure;
wherein the second spray nozzle is located above the first spray nozzle and is oriented in towards the central region of the chamber,
wherein second spray nozzle sprays the liquid conditioning agent onto the first surface of the board as the board is passed through the enclosure.

4. The board treatment system of claim 2, wherein the plurality of spray nozzles comprises:
a second spray nozzle proximate to a fourth side of the enclosure and is oriented in towards the central region of the chamber,
wherein the fourth side of the enclosure is between the first side of the enclosure and the second side of the enclosure,
wherein the fourth side of the enclosure opposes the third side of the enclosure,
wherein second spray nozzle sprays the liquid conditioning agent onto a second surface of the board as the board is passed through the enclosure, and
wherein the second surface of the board opposes the first surface of the board.

5. The board treatment system of claim 2, wherein the plurality of spray nozzles comprises:
a second spray nozzle disposed proximate to a top of the enclosure and is oriented in towards the central region of the chamber, and
wherein second spray nozzle sprays the liquid conditioning agent onto a top surface of the board as the board is passed through the enclosure.

6. The board treatment system of claim 1, wherein the plurality of spray nozzles comprises:
a second spray nozzle disposed proximate to a bottom of the enclosure and is oriented in towards a central region of the chamber, and
wherein second spray nozzle sprays the liquid conditioning agent onto a bottom surface of the board as the board is passed through the enclosure.

7. The board treatment system of claim 1, wherein the plurality of spray nozzles comprises:
a first spray nozzle disposed proximate to a third side of the enclosure and is oriented in towards a central region of the chamber,
wherein the third side of the enclosure is between the first side of the enclosure and the second side of the enclosure, and
wherein first spray nozzle sprays the liquid conditioning agent onto a first surface of the board as the board is passed through the enclosure;
a second spray nozzle proximate to a fourth side of the enclosure and is oriented in towards the central region of the chamber,
wherein the fourth side of the enclosure is between the first side of the enclosure and the second side of the enclosure,
wherein the fourth side opposes the third side of the enclosure,
wherein second spray nozzle sprays the liquid conditioning agent onto a second surface of the board as the board is passed through the enclosure when the second spray nozzle is optionally actuated, and
wherein the second surface of the board opposes the first surface of the board;
a third spray nozzle disposed proximate to a top of the enclosure and is oriented in towards a central region of the chamber,
wherein third spray nozzle sprays the liquid conditioning agent onto a top surface of the board as the board is passed through the enclosure when the third spryer is optionally actuated; and
a fourth spray nozzle disposed proximate to a bottom of the enclosure and is oriented in towards a central region of the chamber, and
wherein fourth spray nozzle sprays the liquid conditioning agent onto a bottom surface of the board as the board is passed through the enclosure when the fourth sprayer is optionally actuated.

8. The board treatment system of claim 7, further comprising:
an internal support frame that secures and orients the first spray nozzle, the second spray nozzle, the third spray nozzle and the fourth spray nozzle,
wherein the internal support frame fits within the chamber of the enclosure, and
wherein the internal support frame is removeable from the chamber of the enclosure.

9. The board treatment system of claim 1, further comprising:
an internal support frame that secures and orients the plurality of spray nozzles and the plurality of brushes,
wherein the internal support frame fits within the chamber of the enclosure, and
wherein the internal support frame is removeable from the chamber of the enclosure.

10. The board treatment system of claim 1, wherein the plurality of brushes comprise:
a first brush with a first brushing end oriented towards the second aperture,
wherein the first brushing end of the first brush is oriented coplanar with a first side of the board, and
wherein the first brushing end of the first brush is in contact with the first side of the board as the board is passing through the enclosure;
an optional second brush with a second brushing end oriented towards the second aperture,
wherein the second brushing end of the second brush is oriented coplanar with a second side of the board that opposes the first side of the board, and
wherein the second brushing end of the second brush is in contact with the second side of the board as the board is passing through the enclosure;
an optional third brush with a third brushing end oriented towards the second aperture,
wherein the third brushing end of the third brush is oriented coplanar with a top side of the board, and
wherein the third brushing end of the third brush is in contact with the top side of the board as the board is passing through the enclosure.

11. The board treatment system of claim 10, wherein the plurality of brushes further comprises:
an fourth brush with a second brushing end oriented towards the second aperture,
wherein the fourth brushing end of the fourth brush is oriented coplanar with a bottom side of the board, and
wherein the fourth brushing end of the fourth brush is in contact with the bottom side of the board as the board is passing through the enclosure.

12. The board treatment system of claim 1, further comprising:
a fluid outlet disposed proximate to a bottom of the enclosure,
wherein unused liquid conditioning agent that is not applied to the untreated board and that is collected in the bottom of the enclosure is retrieved and is returned to a source container of the liquid conditioning agent that is supplying the spray applicator system.

13. The board treatment system of claim 1, further comprising:
a fluid retention tray that is configured to receive the enclosure,
wherein the fluid retention tray retains any incidental spillage of the liquid conditioning agent from the enclosure.

14. The board treatment system of claim 13, further comprising:
a securing frame that is configured to secure the fluid retention tray to a work surface,
wherein the secured fluid retention tray prevents unintentional movement of the enclosure during use.

15. The board treatment system of claim 13, wherein the fluid retention tray comprises:
a drain that releases liquid conditioning agent that is collected in the fluid retention tray.

16. The board treatment system of claim 1, further comprising:
a plurality of strips of flexible material located over the second aperture,
wherein the plurality of strips of flexible material permit passage of the board through the second aperture while retaining any excess liquid conditioning agent within the interior of the chamber.

17. The board treatment system of claim 1, further comprising:
a detector that detects entry of the untreated board through the first aperture,
wherein the spray applicator system is actuated in response to the detector detecting the entry of the untreated board through the first aperture such that the liquid conditioning agent begins to spray out from at least one of the plurality of spray nozzles.

18. The board treatment system of claim 1, wherein the enclosure is a plastic tote box.
